(19) United States
(12) Patent Application Publication
(10) Pub. No.: US 2002/0021074 A1
(43) Pub. Date: Feb. 21, 2002

(54) Color selection mechanism for cathode ray tube and color cathode ray tube

(76) Inventor: Yoshiro Horiuchi, Tokyo (JP)

Correspondence Address: Ronald P. Kananen, RADER, FISHMAN & GRAUER, P .L.L.C, Suite 501, 1233 20th Street, NW, Washington, DC, 20036, US

(21) Appl. No.: 09/878,287

(22) Filed: Jun. 12, 2001

(30) Foreign Application Priority Data
Jun. 20, 2000 (JP) P2000-185046

(51) Int. Cl. H01J 29/80

(52) U.S. Cl. 313/407

(57) ABSTRACT

A color selection mechanism for a cathode ray tube and a cathode ray tube with the color selection mechanism of the present invention constitute a color selection mechanism for a cathode ray tube wherein support members have substantially angular-U-shaped sections and an opposing side is longer than a side on which a substantially angular-U-shaped color selection electrode extends, or a color selection mechanism for a cathode ray tube wherein each of elastic members is formed of a hollow member constituted by a member having an angular-U-shaped section and a closing plate for closing the opening of the member. A color cathode ray tube is equipped with the color selection mechanism. As a result, an increase in cost of materials is restrained as well as the mechanical strength of a frame of a color selection mechanism is increased.

### BACKGROUND OF THE INVENTION

1. Field of the Invention

The present invention relates to a color selection mechanism for a cathode ray tube and a color cathode ray tube comprising a color selection mechanism.

2. Description of the Related Art

As a color selection mechanism for a color cathode ray tube, for example, a color selection mechanism 51 called an aperture grill as shown in FIG. 1 is known. In this color selection mechanism 51, a frame-like metal frame 56 constituted by a pair of opposing support members 52 and 53 and a pair of elastic members 54 and 55 welded to be extended between the support members 52 and 53 is arranged, and a mask member, i.e., a color selection electrode 60 having a large number of slit-like electron beam apertures 59 aligned between the opposing support members 52 and 53 of the frame 56 along one direction, i.e., a horizontal direction (direction X) on a screen is extended.

The support members 52 and 53 constituting the frame 56 is constituted by a metal material having an L-shaped section. The support members 52 and 53 serve as beams for holding the color selection electrode 60 of the color selection mechanism 51.

The elastic members 54 and 55 are constituted by a hollow or solid arc-like square bars (metal materials) having sufficient spring elasticities. The elastic members 54 and 55 function to absorb temporary extension of the color selection electrode 60 caused by plastic deformation of the color selection electrode 60 in the process of manufacturing the cathode ray tube and irradiation of an electron beam in an operation of the cathode ray tube.

The color selection electrode 60 is constituted by a metal thin plate consisting of, e.g., a stainless material. In the color selection electrode 60, a large number of narrow-belt-like grid elements 58 are aligned at a predetermined pitch in the above direction, and each of the long slit-like electron beam apertures 59 is formed between adjacent grid elements 58 in the vertical direction (direction Y) on the screen.

Here, in order to apply a tension to the entire frame 56 to obtain a predetermined tension distribution, the support members 52 and 53 and the elastic members 54 and 55 must be tough.

Therefore, in order to increase a mechanical strength (sectional quadratic moment), a plate thickness t1 and a dimensional ratio h1/d1 (see the sectional view of each of the support members 52 and 53 in FIG. 2) of a longitudinal dimension h1 and a lateral dimension d1 of the L-shaped section in each of the support members 52 and 53 and a dimensional ratio of a longitudinal dimension h2 and a lateral dimension d2 of the drawn solid rod-like shape in each of the elastic members 54 and 55, a diameter r2 of a pipe (seam welded pipe or seamless pipe) and a plate thickness t2, or the like are changed, respectively (see sectional views of the elastic members 54 and 55 in FIG. 3).

However, when the mechanical strengths of the support members 52 and 53 are to be increased; as shown in FIG. 2, in order to block an electron beam EB, a design is made such that each margin DE is formed between portions of the support members 52 and 53 in the lateral direction when the electron beam EB is deviated to a distal end 59A of the electron beam aperture 59.

Therefore, the lateral dimension d1 of the L-shaped section of each of the support members 52 and 53 is limited, and only the plate thickness t1 can be freely changed.

On the other hand, in order to increase the mechanical strengths of the elastic members 54 and 55, a solid member, e.g., a solid rod shown in FIG. 3A has a price lower than a hollow member, e.g., a hollow pipe shown in FIG. 3B, but is heavier than the hollow pipe. The hollow pipe is light, but is expensive.

Since a hollow square member shown in FIG. 3C has general purpose properties poorer than that of a hollow pipe, the hollow square member is more expensive.

In particular, in a color selection mechanism 51 for a large-scale cathode ray tube, since the weight of the frame 56 is considerably heavy, the cost of materials also increases disadvantageously.

### SUMMARY OF THE INVENTION

In order to solve the above problem, according to the present invention, a color selection mechanism for a cathode ray tube which can suppress an increase in cost of materials and can increase the mechanical strength of the frame of the color selection mechanism and a color cathode ray tube comprising the color selection mechanism.

A color selection mechanism for a cathode ray tube according to the present invention is formed such that a color selection electrode is extended over a frame constituted by a pair of support members and a pair of elastic members, and each of the elastic members is formed by a hollow member constituted by a member having an angular-U-shaped section and a closing plate for closing the opening of the member having the angular-U-shaped section.

According to the configuration of the color selection mechanism for a color cathode ray tube according to the present invention, since each of the elastic members is formed by the hollow member constituted by the member having the angular-U-shaped section and the closing plate for closing the opening of the member having the angular-U-shaped section, the elastic member is made hollow to reduce the weight of the elastic member, and the mechanical strength of each of the elastic members having the angular-U-shaped section can be increased by the closing plate. In this manner, when the mechanical strength of the elastic members increases, even though the thicknesses or the dimensions of the elastic members are reduced to decrease the weight of the elastic member, a predetermined mechanical strength can be secured.

A color selection mechanism according to the present invention is formed such that a color selection electrode is extended over a frame constituted by a pair of support members substantially angular-U-shaped section, and an opposing side is longer than a side of substantially angular-U-shape on which the color section electrode is extended.

According to the configuration of the color selection mechanism for the cathode ray tube, since each of the support members has the substantially angular-U-shape, each of the support members can have a mechanical strength higher than that of a conventionally used support member having a substantially L shape.

In addition, since the side of the substantially angular-U-shape on which the color selection electrode is extended is longer than the opposing side, the mechanical strength can be secured on the opposing side, and the orbit of an electronic beam of the cathode ray tube can be prevented from being blocked on the side on which the color selection electrode is extended.

When the mechanical strength of each of the support members increases to resultant reduce the thickness and the dimensions of the support members in order to reduce the weights, a predetermined mechanical strength can be secured.

A color cathode ray tube according to the present invention includes a color selection mechanism formed such that a color selection electrode is extended over a frame constituted by a pair of support members and a pair of elastic members, wherein each of the elastic members is formed by a hollow members constituted by a member having an angular-U-shaped section and a closing plate for closing the opening of the member having the angular-U-shaped section.

According to the configuration of the color cathode ray tube according to the present invention, the color cathode ray tube includes the color selection mechanism in which each of the elastic members is formed by the hollow member constituted by the member having the angular-U-shaped section and the closing plate for closing the opening of the member having the angular-U-shaped section. For this reason, an increase in mechanical strength and a reduction in weight of each of the elastic members of the color selection mechanism are achieved, so that a reduction in weight of the color cathode ray tube can be achieved.

A color cathode ray tube according to the present invention includes a color selection mechanism formed such that a color selection electrode is extended over a frame constituted by a pair of support members and a pair of elastic members, wherein each of the support members has a substantially angular-U-shaped section, and a side of substantially angular-U-shape on which the color selection electrode is extended is longer than an opposing side.

According to the color cathode ray tube of the present invention, each of the support members has the substantially angular-U-shaped section, and an opposing side is longer than the side of the substantially angular-U-shape on which the color selection electrode is extended. For this reason, an increase in mechanical strength of the support members of the color selection mechanism can be achieved. Even though the thicknesses or the dimensions of the support members are reduced to reduce the weights, a mechanical strength equal to that of a conventional color selection mechanism can be maintained. In this manner, a reduction in weight of the color cathode ray tube can be achieved.

### BRIEF DESCRIPTION OF THE DRAWINGS

FIG. 1 is a schematic view (perspective view) of a conventional color selection mechanism for a cathode ray tube;

FIG. 2 is a sectional view of a support member of the conventional color selection mechanism for the cathode ray tube;

FIGS. 3A to 3C are sectional views of elastic members of the conventional color selection mechanism;

FIG. 4 is a schematic view (perspective view) of a color selection mechanism according to an embodiment of the present invention;

FIG. 5A is a sectional view of a support member of the present invention, and

FIG. 5B is an enlarged view (perspective view) of the support member of the present invention;

FIG. 6A is a sectional view (sectional view along a line A-A in FIG. 4) of an elastic member of the present invention;

FIG. 6B is a side view of the elastic member of the present invention viewed from the horizontal direction;

FIG. 6C is a side view of the elastic member of the present invention viewed from the vertical direction;

FIG. 7A is a sectional view of the elastic member equipped with a temperature compensating member;

FIG. 7B is a side view of the elastic member equipped with the temperature compensating member viewed from the horizontal direction;

FIG. 8 is a schematic view of a color cathode ray tube comprising a color selection mechanism of the present invention;

FIG. 9 is a graph obtained by comparing tension distribution of a color selection electrode of a color selection mechanism of the present invention with tension distribution of a color selection electrode of a conventional color selection mechanism;

FIGS. 10A and 10B are sectional views of support members of another embodiment;

FIG. 11A is a perspective view of an elastic member of another embodiment;

FIG. 11B is a side view of the elastic member of another embodiment viewed from the horizontal direction;

FIGS. 12A and 12C are perspective views of elastic members of further another embodiment of the present invention;

FIG. 12B is a sectional view along a line B-B of the elastic member of FIG. 12A.

### DETAILED DESCRIPTION OF THE PREFERRED EMBODIMENTS

The present invention is a color selection mechanism for a cathode ray tube formed such that a color selection electrode is extended over a frame constituted by a pair of support members and a pair of elastic members, wherein each of the elastic members is formed by a hollow member constituted by a member having an angular-U-shaped section and a closing plate for closing the opening of the member having the angular-U-shaped section.

According to the present invention, in the above-mentioned color selection mechanism for a cathode ray tube, the closing plate of each of the elastic members consists of a material having a coefficient of thermal expansion larger than that of the member having an angular-U-shaped section of the elastic member.

According to the present invention, in the above-mentioned color selection mechanism for the cathode ray tube, a temperature compensation member is fixed to each of the elastic members.

The present invention is a color selection mechanism for a cathode ray tube formed such that a color selection electrode is extended over a frame constituted by a pair of support members and a pair of elastic members, wherein each of the support members has a substantially angular-U-shaped section, and an opposing side is longer than a side of substantially angular-U-shape on which the color selection electrode is extended.

According to the present invention, in the above-mentioned color selection mechanism for the cathode ray tube, a free end of each of the support members on a side on which the color selection electrode is extended is inclined along the orbit of the maximum incident angle of an electronic beam.

According to the present invention, in the above-mentioned color selection mechanism for the cathode ray tube, a free end of each of the support members on a side on which the color selection electrode is bent on an opposing side.

The present invention is a color cathode ray tube formed such that a color selection electrode is extended over a frame constituted by a pair of support members and a pair of elastic members, including a color selection mechanism in which each of the elastic members is formed by a hollow member constituted by a member having an angular-U-shaped section and a closing plate for closing the opening of the member having the angular-U-shaped section.

The present invention is a color cathode ray tube formed such that a color selection electrode is extended over a frame constituted by a pair of support members and a pair of elastic members, including a color selection mechanism in which each of the support members has a substantially angular-U-shaped section, and an opposing side is longer than a side of substantially angular-U-shape on which the color selection electrode is extended.

FIG. 4 shows, as an embodiment of the present invention, a schematic view (perspective view) of a color selection mechanism for a color cathode ray tube.

The color selection mechanism 1 is called an aperture grill. In the color selection mechanism 1, a frame-like metal frame 6 constituted by a pair of opposing support members 2 and 3 and a pair of elastic members 4 and 5 welded to be extended between both the ends of the support members 2 and 3 is arranged, and a mask member, i.e., a color selection electrode 10 having a large number of slit-like electron beam apertures 9 aligned between the opposing support members 2 and 3 of the metal frame 6 along one direction, i.e., a horizontal direction (direction X) on a screen is extended.

The color selection electrode 10 is constituted by a metal thin plate consisting of, e.g., a stainless material. In the color selection electrode 10, a large number of narrow-belt-like grid elements 8 are aligned at a predetermined pitch in the above direction, and each of the long slit-like electron beam apertures 9 is formed between adjacent grid elements 8 in the vertical direction (direction Y) on the screen.

In this embodiment, in particular, the support members 2 and 3 and the elastic members 4 and 5 constituting the frame 6 are processed by press molding to have U-shaped sections, respectively.

In addition, a reinforcing plate 13 is welded as a lid to an opening of each of the elastic members 4 and 5 each having an angular-U-shaped section.

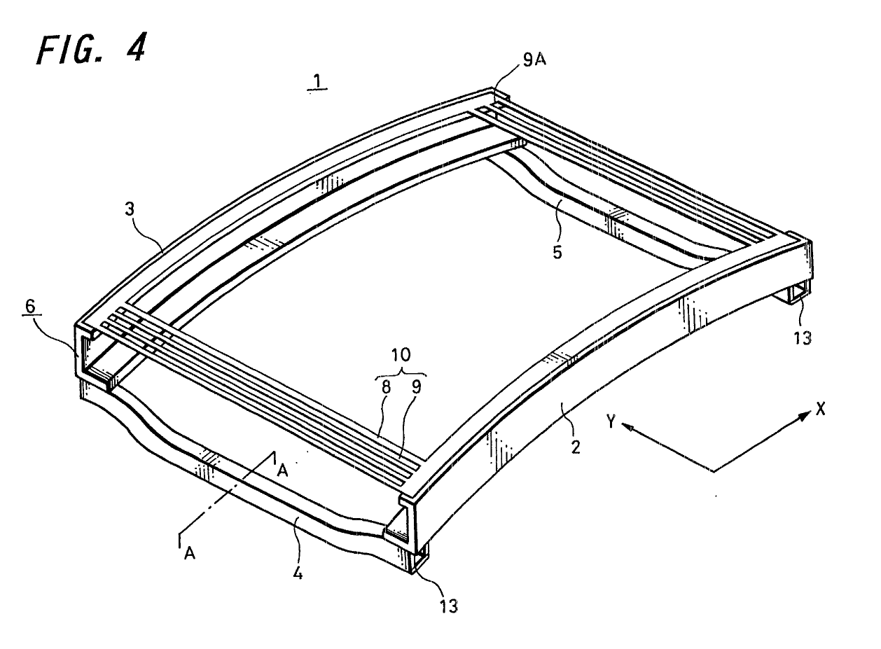

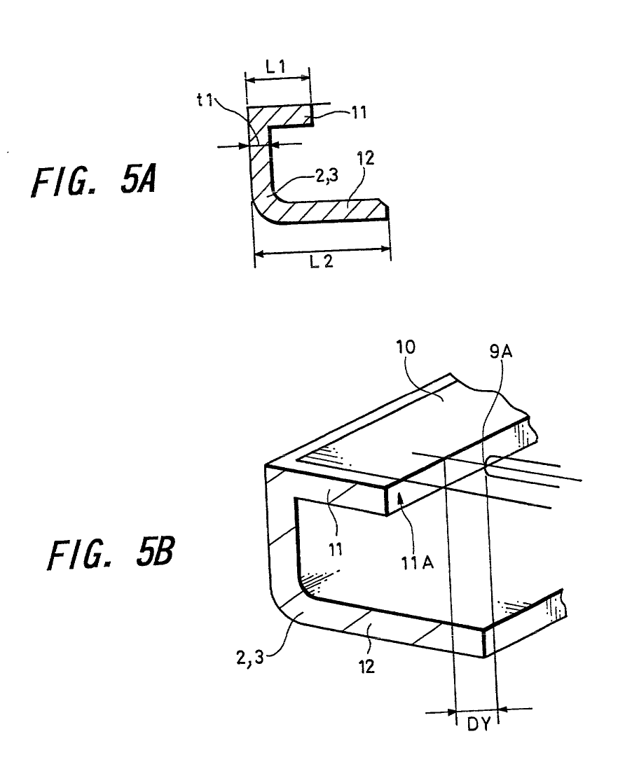

A sectional view of each of the support members 2 and 3 is shown in FIG. 5A, and a an enlarged view of main part of each of the support members 2 and 3 is shown in FIG. 5B.

In addition, of the angular-U-shaped section of each of the support members 2 and 3, a portion 11 on a side on which the color selection electrode 10 is extended and a portion 12 opposing the portion 11 will be regulated as follows.

1) The portion 12 (length L2) is formed to be longer than the portion 11 (length L1) on the which the color selection electrode 10 is extended. More specifically, L1<L2 is satisfied.

2) A distance DY is set between an end face 11A of the portion 11 on the side on which the color selection electrode 10 is extended and a distal end 9A of the slit-like electron beam aperture 9. As this distance DY, 2 mm or more is preferably secured over the entire area of the color selection electrode 10.

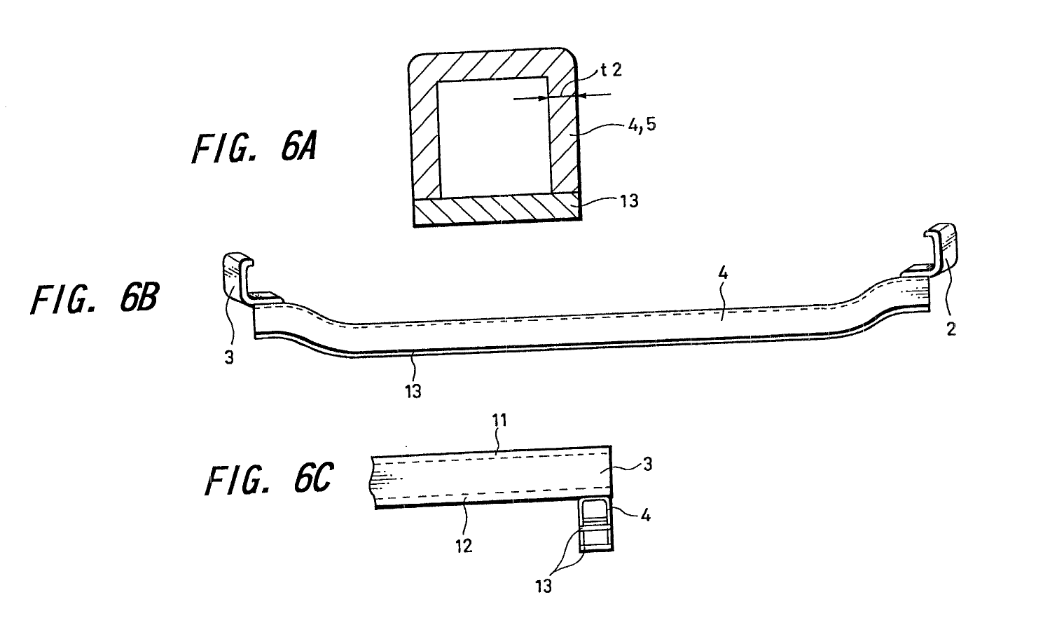

A sectional view (sectional view along an A-A portion in FIG. 4) of each of the elastic members 4 and 5 is shown in FIG. 6A. A side view obtained by viewing the elastic member in a horizontal direction (direction X) is shown in FIG. 6B, and a side view obtained by viewing the elastic member in a vertical direction (direction Y) is shown in FIG. 6C.

Each of the elastic members 4 and 5 is occluded such that, as described above, the reinforcing plate 13 (closing plate) is fixed to the angular-U-shaped opening. In this manner, the elastic member and the reinforcing plate 13 form a hollow square sectional shape.

The support members 2 and 3 are fixed to the upper surfaces of the end portions of each of the elastic members 4 and 5 in the vertical direction (direction Y), and curved portions each having a moderate curve are formed at portions before positions where the support members 2 and 3 are fixed to form steps between the end portions and the central portion. In addition, the ends of the elastic member are opened in the vertical direction (direction Y).

The elastic members 4 and 5 and the reinforcing plates 13 may consist of materials which are different from each other or may consist of the same material.

The sectional shape, the material, and the coefficient of thermal expansion of the reinforcing plate 13 are appropriately selected in accordance with a predetermined tension or the characteristics of the cathode ray tube.

The reinforcing plates 13 can be fixed to the elastic members 4 and 5 by, e.g., so-called Tig welding, i.e., laser welding.

The number of welded points is appropriately changed depending on the tension of the color selection electrode 10 and the characteristics of the color cathode ray tube.

As the number of welded points with the reinforcing plate 13 is large, the angular-U-shaped section can be prevented from being extended.

The reinforcing plates 13 and the elastic members 4 and 5 may be welded to each other over the entire length. In this case, although the cost of welding may increase, the mechanical strength of the elastic members 4 and 5 advantageously increase.

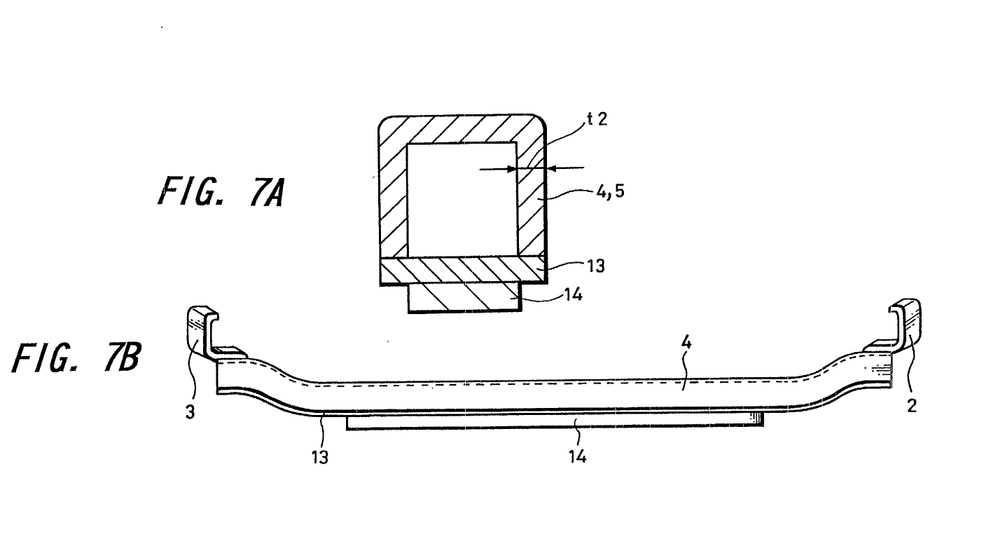

A temperature compensation member (STC) may be fixed to each of the elastic members 4 and 5. For example, FIGS. 7A and 7B show schematic views when a temperature compensation member 14 is fixed to each of the elastic members 4 and 5 shown in FIG. 6A and 6B.

As shown in FIGS. 7A and 7B the temperature compensation member 14 is fixed to a surface of the reinforcing plate (closing plate) 13 on the opposite side of the angular-U-shaped elastic member 4 or 5. The temperature compensation member 14 consists of a material, erg., SUS 304 having a larger coefficient of thermal expansion than the elastic members 4 and 5 (consisting of an SCM-based steel material).

In this manner, each of the elastic members 4 and 5 has a bimetal structure. When the temperature increases, since the expansion of the temperature compensation member 14 is larger than the elastic member, stress internally pressing the support members 2 and 3 fixed to each of the elastic members 4 and 5 is generated. The stress serves as reaction force against the expansion of the color selection electrode 10 caused by the increase in temperature, so that the expansion of the color selection electrode 10 can be suppressed.

More specifically, when the temperature compensation member 14 is fixed, even though the color selection electrode 10 expands in a blackening process, the elastic members 4 and 5 are contracted by the bimetal effect to make it possible to moderate the expansion of the color selection electrode 10.

Furthermore, in an operation of the color cathode ray tube, even though the color selection electrode 10 is deformed, the elastic members 4 and 5 are contracted by the bimetal effect to make it possible to correct the color selection electrode 10.

In addition, in place of the temperature compensation member 14 fixed to the reinforcing plate 13 as shown in FIG. 7, the reinforcing plate 13 having the configuration shown in FIGS. 6A and 6B may consist of a material having a coefficient of thermal expansion larger than that of the elastic members 4 and 5 and may also serve as a temperature compensation material.

In this case, when a temperature increases, the expansion of the reinforcing plate 13 is larger than the expansion of the elastic members 4 and 5, and the same stress as that in the case shown in FIG. 7 is generated.

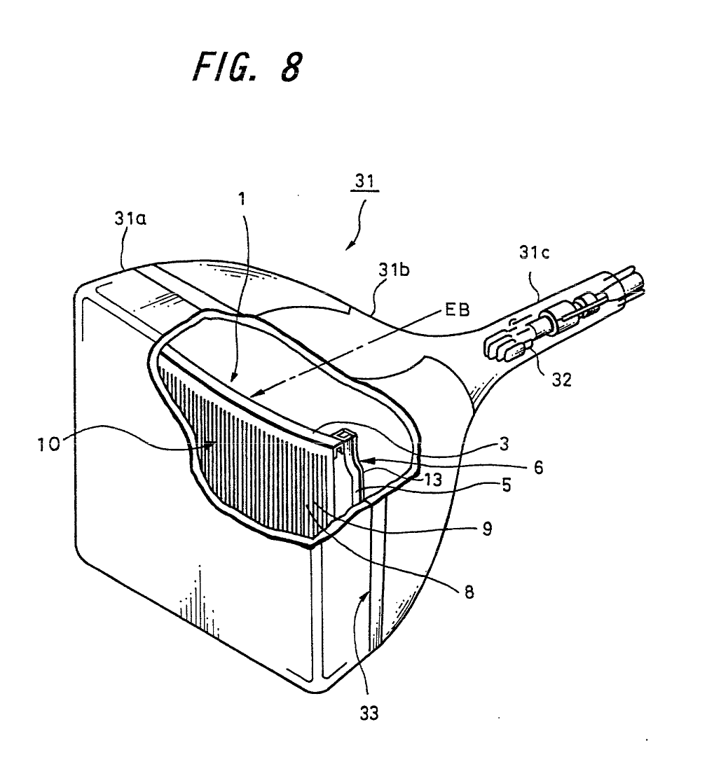

A schematic view (perspective view showing a part of the inside) of a color cathode ray tube comprising the color selection mechanism 1 having the configuration of this embodiment is shown in FIG. 8.

In this color cathode ray tube 31, a fluorescent surface (not shown) is formed in a panel portion 31a formed on the front surface of the cathode ray tube body, and the color selection mechanism 1 having the above configuration is arranged to have a predetermined interval in opposite to the fluorescent surface.

An electron beam EB emitted from an electron gun 32 arranged at a neck portion 31c of the cathode ray tube body is guided to the fluorescent surface through the electron beam apertures 9.

The panel portion 31a and a funnel portion 31b of the cathode ray tube body consist of, e.g., glass, and the panel portion 31a and the funnel portion 31b are connected to each other by a sealing portion 33 to constitute the cathode ray tube body.

The color cathode ray tube comprising the color selection mechanism 1 having the above configuration, so that the mechanical strengths of the support members 2 and 3 and the elastic members 4 and 5 of the frame 6 of the color selection mechanism 1 are increased. For this reason, even though the thicknesses and the dimensions of the support members 2 and 3 and the elastic members 4 and 5 of frame 6 are reduced to reduce the weight of the color selection mechanism 1, predetermined mechanical strengths can be secured.

As a result, a reduction in weight of the color cathode ray tube 31 can be achieved.

Therefore, even though the color cathode ray tube increases in size, an increase in weight can be suppressed.

Furthermore, the impact resistance of the color cathode ray tube can also be improved.

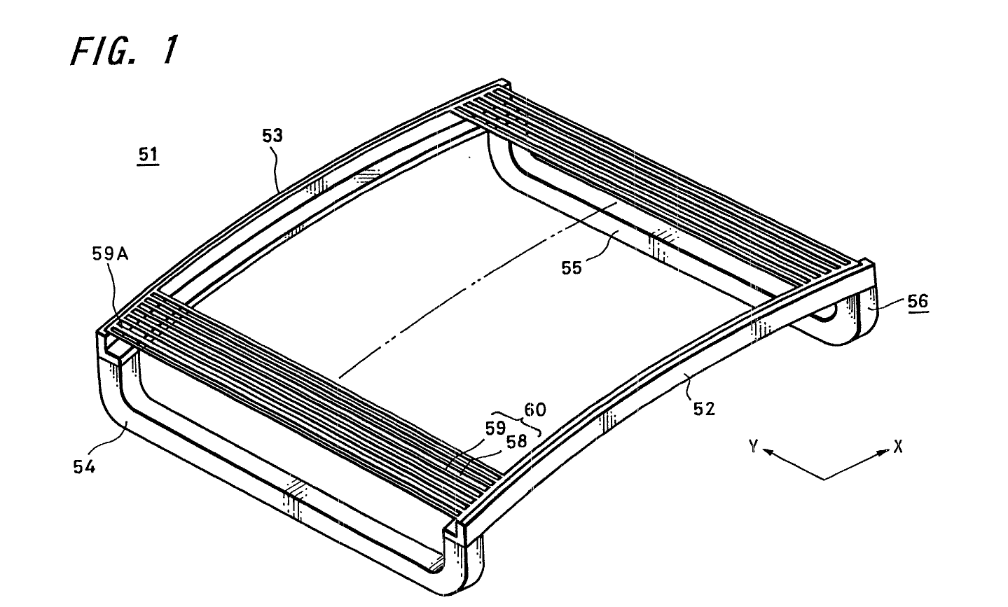

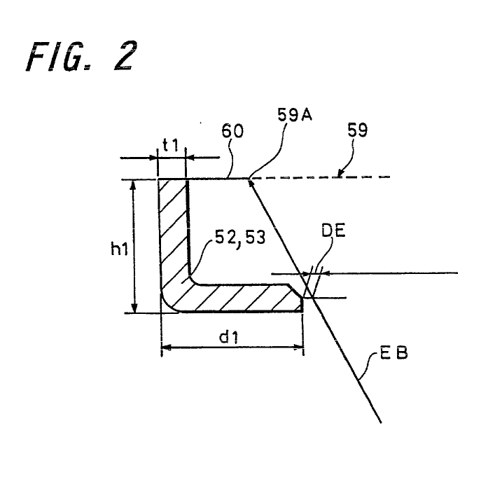

The color selection mechanism 1 having the above configuration and a conventional color selection mechanism 51 shown in FIG. 1 were compared with each other with respect to the tension distributions of the color selection electrodes 10 subjected to a blackening process.

A color selection mechanism of a 29-inch color cathode ray tube was measured.

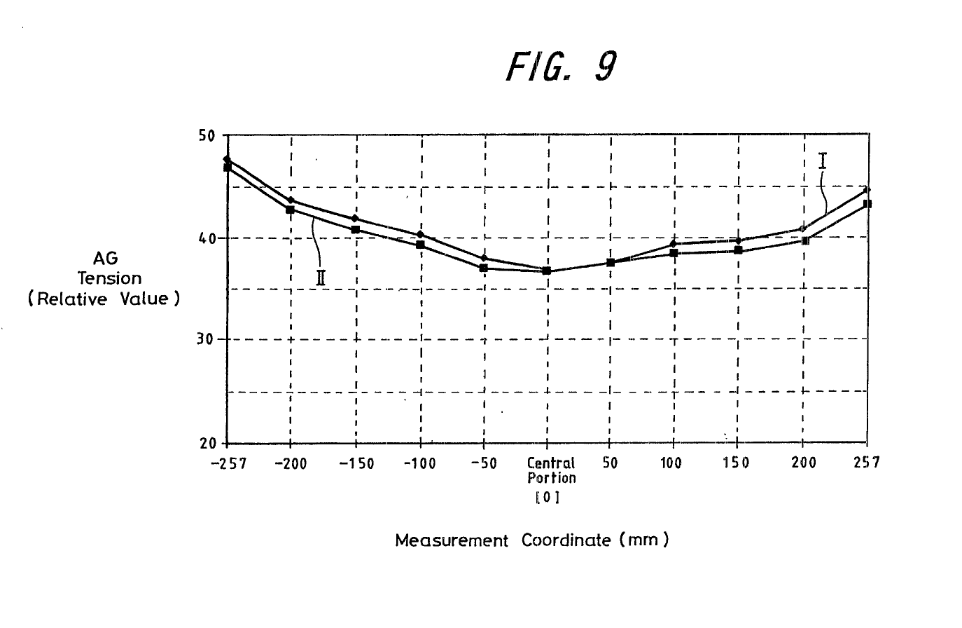

In each of the color selection mechanisms 1 and 51, a tension distributions between both the ends (−257 mm and +257 mm) of the color selection electrode 10 in the horizontal direction (direction X) is shown in FIG. 9 as a relative value.

The conventional color selection mechanism 51 is represented by a mark ♦ (line I), and the color selection mechanism 1 according to the present invention is represented by a mark ▪ (line II).

With reference to FIG. 9. although the color selection mechanism 1 according to the present invention had a tension slightly different from the tension of the color selection mechanism 51 due to a reduction in weight of the color selection mechanism 1, and the difference did not adversely affect the characteristics of the color cathode ray tube. It was confirmed that a desired tension distribution could be obtained.

According to the embodiment described above, since the sections of the support members 2 and 3 are made U-shaped, the mechanical strengths of the support members 2 and 3 can be increased.

The sections of the elastic members 4 and 5 are made U-shaped, and the reinforcing plates 13 are arranged at the openings of the angular-U-shapes to close the angular-U-shaped members, so that the mechanical strengths of the elastic members 4 and 5 can be increased.

The rigidity of the frame 6 can be increased by increasing the mechanical strengths of the support members 2 and 3 and the elastic members 4 and 5.

That is, the mechanical strength can be secured as strong as the conventional support members 52 and 53 and the elastic members 54 and 55, even if the thicknesses t1 and t2 of the support members 2 and 3 and the elastic members 4 and 5 are thinned.

In this manner, the thicknesses t1 and t2 of the support members 2 and 3 and the elastic members 4 and 5 are reduced while keeping predetermined rigidity of the frame 6, and a reduction in weight of the frame 6 can be achieved.

In place of the reductions of the thicknesses t1 and t2 of the support members 2 and 3 and the elastic members 4 and 5, longitudinal and lateral dimensions (h1, d1, h2, d2) and the like are reduced, so that a reduction in weight can also be achieved.

Since secondarily processed solid rods or pipes (seam welded pipes or seamless pipes) are not used for the elastic members 4 and 5, inexpensive and general-purpose materials can be used for the elastic members 4 and 5. A reduction in weight can be achieved while suppressing the cost of materials from increasing.

Since the materials or the like of the reinforcing plates 13 of the elastic members 4 and 5 can be changed depending on the characteristics required by the color cathode ray tube, the degree of freedom of the design of the color cathode ray tube becomes high.

In addition, since the support members 2 and 3 and the elastic members 4 and 5 have U-shaped sections, the support members 2 and 3 and the elastic members 4 and 5 can be easily formed by bending steel plates.

Therefore, when members having U-shaped section and several thicknesses are prepared, the member can cope with the frames 6 of all types of color cathode ray tubes by changing only the sizes of the electron beam apertures 9, and a stock of materials can be shortened.

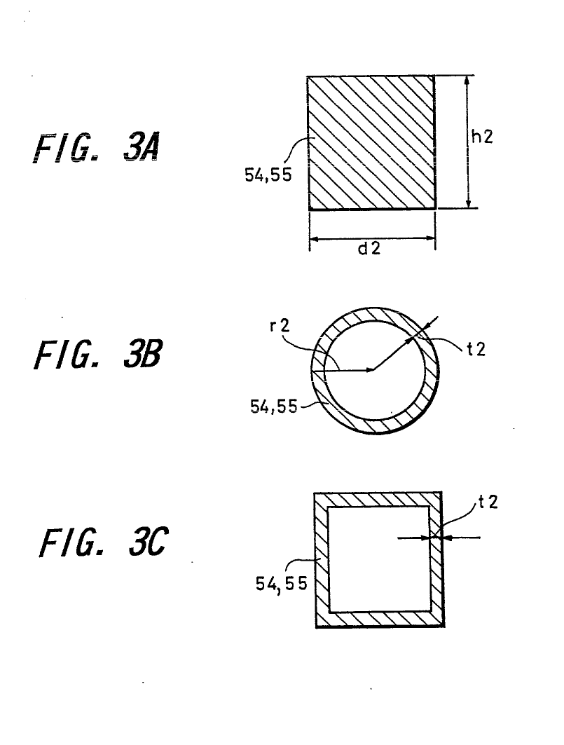

Since the pipe shown in FIG. 3 is not used for the elastic members 4 and 5, a cleaning process for removing dust generated from the inner surface of the pipe need not be arranged.

More specifically, before a steel plate is bent to form an angular-U-shape, dust can be removed in advance.

Thereafter, even though wastes are generated in the bending process, the wastes can be easily removed before the elastic members 4 and 5 are combined to the reinforcing plates 13.

Since the ends of the elastic members 4 and 5 are opened, no gases are sealed in the elastic members 4 and 5.

Therefore, unlike a case using a pipe, a gas releasing hole need not be formed. For this reason, a process of forming a gas releasing hole, a process of gas releasing leakage check, a piping process, a pin removing process, and a hole sealing process can be omitted.

Subsequently, as another embodiment of the present invention, other configurations of support members will be described below.

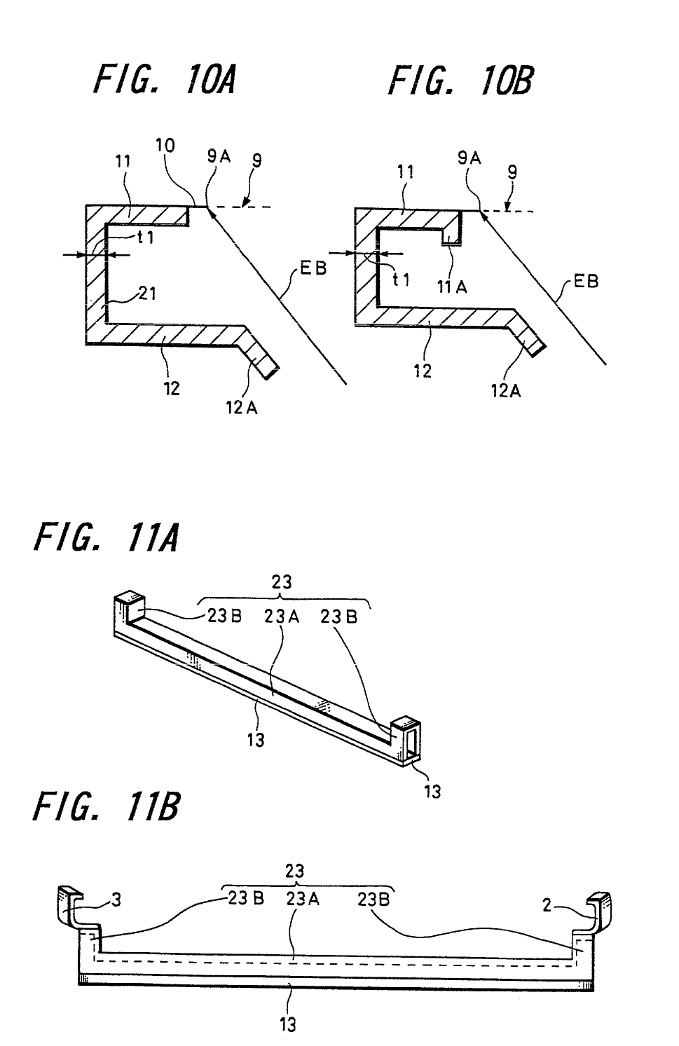

FIGS. 10A and 10B show sectional views of the support members of a color selection mechanism.

A support member 21 shown in FIG. 10A, like the support members 2 and 3 shown in FIG. 5, has a portion 11 on a side on which a color selection electrode 10 is extended and a portion 12 opposing the portion 11.

A free end 12A of the opposing portion 12 is elongated along the orbit of an electron beam EB having the maximum incident angle, and is formed almost in parallel to the orbit.

In this manner, the free end 12A is elongated along the orbit of the electron beam EB having the maximum incident angle, so that the opposing portion 12 is bent to have a V shape. For this reason, the mechanical strength of the opposing portion 12 can be made higher than that in the case in which the opposing portion 12 is straight as in the support members 2 and 3 shown in FIG. 5.

In the support member 22 shown in FIG. 10B, a free end 11A of the portion 11 on the side on which the color selection electrode 10 is extended in the support member 21 shown in FIG. 10A is bent toward the opposing portion 12.

In this manner, when the free end 11A is bent toward the opposing portion 12 the mechanical strength of the portion 11 on the side on which the color selection electrode 10 is extended can be increased.

For this reason, the mechanical strength of the support member 22 can be made higher than those of the support members 2 and 3 shown in FIG. 5.

Subsequently, as still another embodiment of the present invention, another configuration of an elastic member will be described below.

In the previous embodiment shown in FIGS. 4 and 6, the portions of the steps in the elastic members 4 and 5 have moderately curved shapes.

In this embodiment, as shown in a perspective view in FIG. 11A and a side view in a horizontal direction (direction X) in FIG. 11B, an elastic member 23 is straightly formed, and end portions 23B of the elastic member 23 are elongated perpendicularly to a straight portion 23A. As shown in FIG. 11B, support members 2 and 3 are fixed to the end portions 23B elongated perpendicularly to the straight portion 23A.

Also in the elastic member 23 having this configuration, as in the elastic members 4 and 5 of the previous embodiment, the member 23 having an angular-U-shaped section is combined to a reinforcing plate 13 to constitute a hollow elastic member 23. For this reason, a reduction in weight of the elastic member 23 can be achieved. Even though the thicknesses and the dimensions of the elastic member 23 are reduced, the mechanical strength of the elastic member 23 can be secured.

In addition, in comparison of the hollow member shown in FIG. 3, the elastic member 23 has the following advantages. That is, the cost of materials can be reduced, and the number of steps can be reduced by omitting a cleaning process, a process of foxing a gas releasing hole, and the like.

Subsequentially, as still another embodiment of the present invention, still another configuration of an elastic member will be described below.

In the previous embodiment shown in FIGS. 4 and 6, the openings of the angular-U-shapes of the elastic members 4 and 5 are formed on the lower side of the color selection mechanism 1 in FIG. 4, i.e., a surface on the electron gun side of the cathode ray tube, and the reinforcing plates 13 are fixed to the openings.

Configurations in which the openings of the angular-U shapes may be formed on other surfaces of the elastic member, i.e., a surface on the color selection electrode side (fluorescent surface side of the cathode ray tube) and a side surface can be used. In any configurations, a reinforcing plate may be fixed to close the opening.

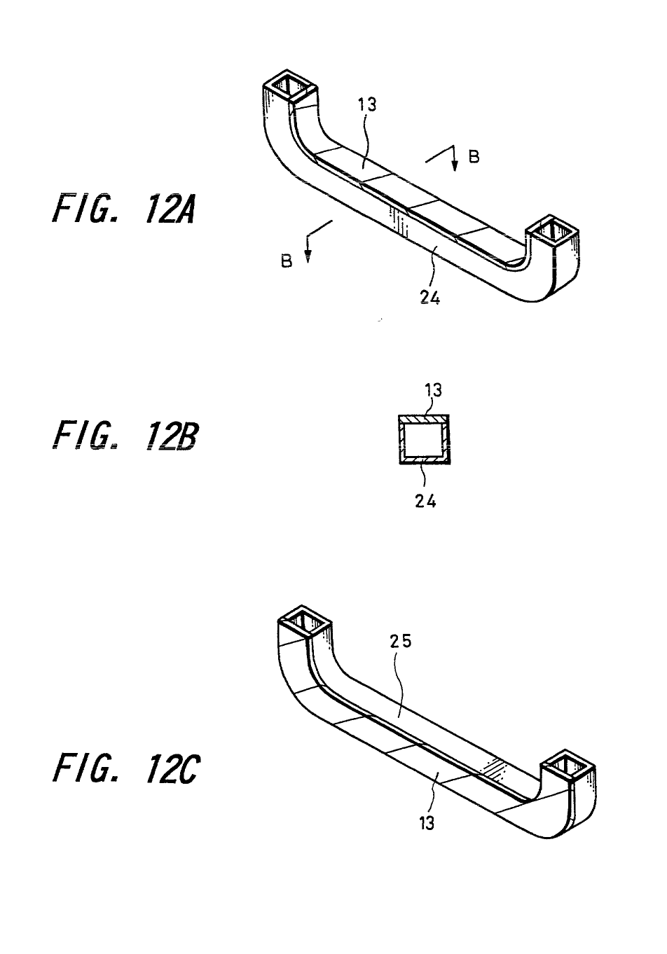

For example, as shown in a perspective view in FIG. 12A and a sectional view along a line B-B of FIG. 12A in FIG. 12B, an arc-like elastic member 24 is formed such that a surface on a color selection electrode side is an opening of the angular-U shape, so as to fix a reinforcing plate 13 to this surface.

In this case, when the material of the reinforcing plate 13 has a coefficient of thermal expansion smaller than that of the material of the elastic member 24, the bimetal effect described above is generated to make it possible to suppress expansion of the color selection electrode.

In addition, for example, as shown in a perspective view in FIG. 12C, a configuration in which a side surface of an arc-like elastic member 25 is an opening of an angular-U-shape, so as to fix a reinforcing plate 13 to the side surface.

The elastic member having an angular-U-shaped section is not limited to the angular shape. A shape in which a portion except for the opening is curved (curved-U-shape, part of an arc, or the like) may be effected. However, since a spring to be fixed to a panel pin or a temperature compensation member are welded to the elastic member, at least a portion to which the elastic member is welded is desirably flat.

In each of the embodiments described above, the present invention is applied to the color selection mechanism 1 of an aperture grill type in which the color selection electrode 10 has the slit-like electron beam apertures 9. However, the present invention is applied to a color selection mechanism having another configuration in which, for example, electron beam apertures have slot-like shapes or circular shapes, so that the mechanical strength of the frame can be increased.

The present invention is not limited to the embodiments described above, and various configurations can be effected without departing from the spirit and scope of the present invention.

Having described preferred embodiments of the present invention with references to the accompanying drawings, it is to be understood that the present invention is not limited to the above-mentioned embodiments and that various changes and modifications can be effected therein by one skilled in the art without departing from the spirit or scope of the present invention as defined in the appended claims.

What is claimed is:

1. A color selection mechanism for a cathode ray tube formed such that a color selection electrode is extended over a frame constituted by a pair of support members and a pair of elastic members, wherein
each of the elastic members is formed by a hollow member constituted by a member having an angular-U-shaped section and a closing Plate for closing the opening of the member having the angular-U-shaped section.

2. The color selection mechanism for a cathode ray tube according to claim 1, wherein the closing plate of each of the elastic members consists of a material having a coefficient of thermal expansion larger than that of the member having an angular-U-shaped section of the elastic member.

3. The color selection mechanism for a cathode ray tube according to claim 1, wherein a temperature compensation member is fixed to each of the elastic members.

4. A color selection mechanism for a cathode ray tube formed such that a color selection electrode is extended over a frame constituted by a pair of support members and a pair of elastic members, wherein
each of the support members has a substantially angular-U-shaped section, and an opposing side is longer than a side of angular-U-shape on which the color selection electrode is extended.

5. The color selection mechanism for a cathode ray tube according to claim 4, wherein a free end of each of the support members on a side on which the color selection electrode is extended is inclined along the orbit of the maximum incident angle of an electronic beam.

6. The color selection mechanism for a cathode ray tube according to claim 4, wherein a free end of each of the support members on a side on which the color selection electrode is bent on an opposing side.

7. A color cathode ray tube formed such that a color selection electrode is extended over a frame constituted by a pair of support members and a pair of elastic members, comprising a color selection mechanism in which each of the elastic members is formed of a hollow member constituted by a member having an angular-U-shaped section and a closing plate for closing the opening of the member having the angular-U-shaped section.

8. A color cathode ray tube formed such that a color selection electrode is extended over a frame constituted by a pair of support members and a pair of elastic members, comprising a color selection mechanism in which each of the support members has a substantially angular-U-shaped section, and an opposing side is longer than a side of substantially angular-U-shape on which the color section electrode is extended.
